(19) United States
(12) Patent Application Publication
(10) Pub. No.: US 2025/0166865 A1
(43) Pub. Date: May 22, 2025

(54) SUBMARINE POWER CABLE WITH LONGITUDINAL TAPE

(71) Applicant: NKT HV Cables AB, Lyckeby (SE)

(72) Inventor: Sonny Långström, Karlskrona (SE)

(21) Appl. No.: 18/421,124

(22) Filed: Jan. 24, 2024

(30) Foreign Application Priority Data
Feb. 14, 2023 (EP) 23156549.0

(51) Int. Cl. H01B 7/14; H01B 7/282; H01B 9/00; H01B 13/26

(52) U.S. Cl. CPC H01B 7/14; H01B 7/2825; H01B 9/006; H01B 13/2693

(57) ABSTRACT

A submarine power cable, including: a conductor, an insulation system arranged around the conductor, the insulation system including an inner semiconducting layer, an insulation layer arranged around the inner semiconducting layer, and an outer semiconducting layer arranged around the insulation layer, a metallic water blocking layer arranged around the insulation system, the metallic water blocking layer having a longitudinal weld seam, and a metallic tape arranged radially outside the metallic water blocking layer, wherein the metallic tape extends axially along and is bonded to the weld seam.

### TECHNICAL FIELD

The present disclosure generally relates to submarine power cables.

### BACKGROUND

Submarine power cables have traditionally had a lead sheath which acts as a radial water barrier protecting the insulation system.

There is a trend towards a lead-free radial water barrier design. There have been proposals of water barriers of for example copper, various copper alloys, aluminium, and stainless steel. While lead sheaths can be extruded, sheaths of the replacement metals can generally not, for example because of their high melting temperature.

Typically, the water barrier is made by first longitudinally wrapping a metal tape around the insulation system and then welding opposite edges of the metal tape in the longitudinal direction of the cable. There are however various challenges with the welding process, which may impact the quality of the water barrier.

A local weld defect may for different reasons occur during long time welding processes. For a thin, welded metal sheath, covering the insulation system of a power cable, a weld defect may especially be critical since it could increase the risk for moisture/water ingress into the insulation system, thus potentially increasing the risk of an electrical breakdown.

For long weld process times, and consequently long cable lengths, it is likely difficult to completely monitor the amount and size of possible weld defects present. It is also very cumbersome, if even possible, to perform an inline repair of a critical large weld defect.

EP3792938 discloses a process for manufacturing a power cable comprising: providing a power cable core comprising an electric conductor and having an outer diameter, providing a copper foil having a width such that, after folding of the copper foil to provide a copper sheath around each power cable core, the copper sheath has an inner diameter from 5 to 15 mm greater than the power cable core outer diameter, providing a protective strip over the power cable core in a position substantially matching a welding die, the protective strip having a radially inner and outer surface and being made of copper with a coating, at least on the radially outer surface, made of a metal or a metal alloy having a melting temperature comprised between 90° C. and 250° C., folding the copper foil around the power cable core so as to bring two longitudinal copper foil rims to contact one to the other, welding the two contacted longitudinal copper foil rims with a welding die thus obtaining a copper sheath in form of a tube with a welding seam and having a diameter, reducing the diameter of the copper sheath to put it into direct contact with the power cable core and the protective strip, heating the protective strip and the copper sheath at a temperature higher than the melting temperature of the coating of the strip so that the coating fuses in the welding seam, extruding a polymeric sheath around the copper sheath.

### SUMMARY

In view of the above, an object of the present disclosure is to provide a submarine power cable which solves or at least mitigates the problems of the prior art.

There is hence according to a first aspect of the present disclosure provided a submarine power cable, comprising: a conductor, an insulation system arranged around the conductor, the insulation system comprising an inner semiconducting layer, an insulation layer arranged around the inner semiconducting layer, and an outer semiconducting layer arranged around the insulation layer, a metallic water blocking layer arranged around the insulation system, the metallic water blocking layer having a longitudinal weld seam, and a metallic tape arranged radially outside the metallic water blocking layer, wherein the metallic tape extends axially along and is bonded to the weld seam.

Compared to EP3792938, the position of the metallic tape relative to the weld seam can better be controlled because it is applied over the weld seam instead of underneath it before the welding and the diameter reduction has taken place. It can thus better be ensured that the fusion with the weld seem does in fact take place as desired, to fill any pinholes/cracks/micro-holes along the weld seam.

According to one embodiment the metallic tape extends along the weld seam along the entire axial length of the weld seam.

According to one embodiment the metallic tape is bonded to the weld seam by means of an adhesive or by means of solder.

According to one embodiment the solder has a melting temperature of at most 200° C.

One embodiment comprises an extruded polymeric layer arranged around the metallic water blocking layer.

According to one embodiment the polymeric layer is arranged in direct contact with the metallic tape.

According to one embodiment the metallic water blocking layer has a smooth outer surface.

According to one embodiment the metallic tape is made of the same material as the metallic water blocking layer.

According to one embodiment the metallic water blocking layer comprises one of a copper material, or stainless steel.

According to one example the copper material comprising at least 99 wt. % copper and at most 0.1 wt. % oxygen.

According to one example the copper material is Cu-DHP, Cu-ETP, or Cu—OF. These copper materials are not intentionally alloyed coppers and are one-phase metals which do not undergo any hardening process during solidification, which is the most beneficial for the weld quality.

The stainless steel may according to one example have a chromium equivalent in a range of 16-25 and a nickel equivalent in a range of 11-22 according to a Schaeffler-DeLong constitutional diagram for which the chromium equivalent is calculated according to the formula % Cr+% Mo+1.5× % Si+0.5× % Nb and the nickel equivalent is calculated according to the formula % Ni+0.5× % Mn+30× (% C+% N).

According to one embodiment the stainless steel is an austenitic stainless steel type selected from one of type 304, 304L, 316, or 316L, 316Ti, 316Cb 321, or 347 as defined by ASTM A240/A240M-22b or equivalents thereof according to EN 10088-1:2005.

According to one embodiment the submarine power cable is a high voltage AC or DC submarine power cable.

With high voltage is meant a nominal voltage of the submarine power cable of kV or more.

According to one embodiment the submarine power cable is a dynamic submarine power cable.

According to one embodiment the submarine power cable is a static submarine power cable.

There is according to a second aspect of the present disclosure provided a method of manufacturing a submarine power cable of the first aspect, comprising: a) wrapping a metallic sheath around the insulation system, b) welding opposite edges of the metallic sheath longitudinally to form the metallic water blocking layer with the weld seam, c) laying the metallic tape over and along the weld seam, and d) heating the metallic tape to bond the metallic tape with the weld seam.

According to one embodiment the metallic tape has an inner surface provided with an adhesive or solder, wherein step d) involves melting the adhesive or solder such that the adhesive or solder fuses with the weld seam.

According to one embodiment step d) involves extruding a polymeric layer around the metallic water blocking layer and the metallic tape to thereby cause the heating of the metallic tape.

The welding in step b) may be autogenous welding.

According to one embodiment the autogenous welding is one of laser, tungsten inert gas, TIG, or plasma autogenous welding.

Generally, all terms used in the claims are to be interpreted according to their ordinary meaning in the technical field, unless explicitly defined otherwise herein. All references to “a/an/the element, apparatus, component, means”, etc. are to be interpreted openly as referring to at least one instance of the element, apparatus, component, means, etc., unless explicitly stated otherwise.

### BRIEF DESCRIPTION OF THE DRAWINGS

The specific embodiments of the inventive concept will now be described, by way of example, with reference to the accompanying drawings, in which:

FIG. 1 schematically shows a cross-sectional view of an example of a submarine power cable;

FIG. 2 shows a close-up of a region of the cross-section of the submarine power cable in FIG. 1;

FIG. 3 shows a method of manufacturing a submarine power cable;

FIG. 4 schematically shows a perspective view of autogenous welding of metal sheath arranged around an insulation system; and

FIG. 5 schematically shows a perspective view of a metallic tape provided on the weld seam.

### DETAILED DESCRIPTION

The inventive concept will now be described more fully hereinafter with reference to the accompanying drawings, in which exemplifying embodiments are shown. The inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description.

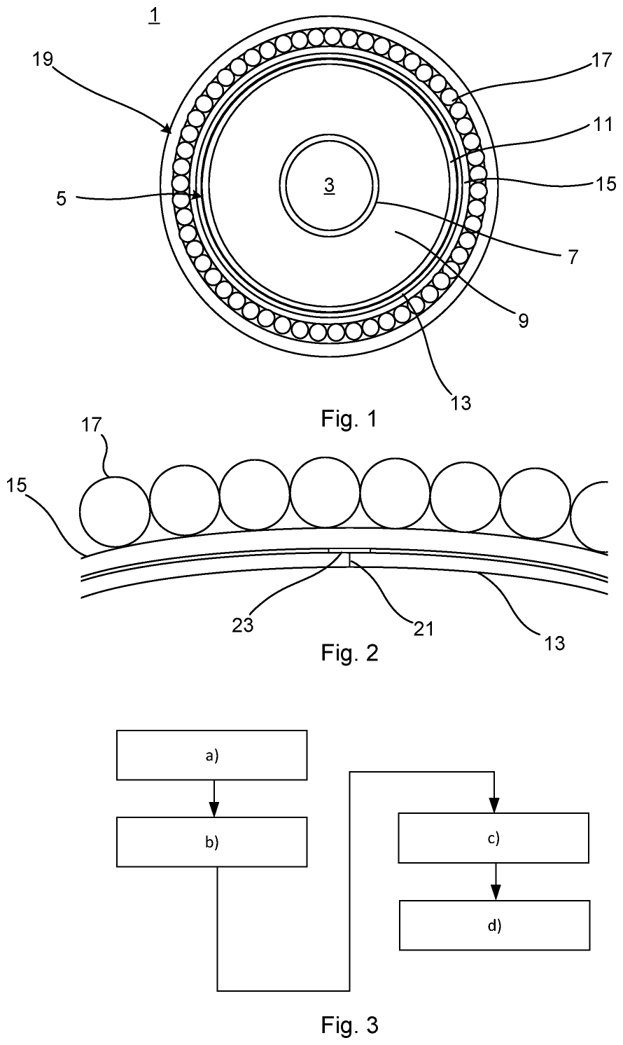

FIG. 1 shows a cross section of an example of a submarine power cable 1. Although the exemplified submarine power cable 1 depicts a single core submarine power cable, the submarine power cable 1 could alternatively be a multi-core submarine power cable.

The submarine power cable 1 may be an AC submarine power cable or a DC submarine power cable.

The submarine power cable 1 comprises a conductor 3, and an insulation system 5 arranged around the conductor 3.

The insulation system 5 comprises an inner semiconducting layer 7 which is arranged around the conductor 3, an insulation layer 9 arranged around the inner semiconducting layer 7, and an outer semiconducting layer 11 arranged around the insulation layer 9.

The insulation system 5 may be an extruded insulation system or a paper-based insulation system which is impregnated with insulating fluid such as an oil.

In case the insulation system 5 is an extruded insulation system, the insulation system comprises a polymer material such as polyethylene, cross-linked polyethylene, polypropylene, ethylene propylene rubber (EPR) or ethylene propylene diene monomer rubber (EPDM).

The submarine power cable 1 also comprises a metallic water blocking layer 13. The metallic water blocking layer 13 may be smooth, i.e., non-corrugated.

The metallic water blocking layer 13 has a longitudinal weld seam. The weld seam may according to one example be formed without any filler material. The metallic water blocking layer 13 may thus have been autogenously welded.

The submarine power cable 1 may comprise a polymeric sheath 15 arranged around the metallic water blocking layer 13.

The submarine power cable 1 may comprise an armour layer comprising a plurality of elongated armour elements 17. The armour layer is arranged around the polymeric sheath 15.

Further, the submarine power cable 1 may comprise an outer sheath or outer serving 19 arranged around armour layer. The outer sheath or outer serving 19 may form the outermost layer of the submarine power cable 1.

In examples in which the submarine power cable is a multi-core submarine power cable, each core would have the general structure described above up until the polymeric sheath 15. The cores are arranged in a stranded configuration with the optional armour layer arranged around all the cores.

FIG. 2 schematically shows a close-up view of some elongated armour elements 17, and the underlying polymeric sheath 15 and metallic water blocking layer 13 of the submarine power cable 1 shown in FIG. 1. The weld seam 21, in cross section, of the metallic water blocking layer 13 is also visible.

The submarine power cable 1 comprises a metallic tape 23 which is arranged radially outside of the metallic water blocking layer 13, along the weld seam 21. The metallic tape 23 thus extends along the longitudinal, or axial, direction of the submarine power cable 1. The metallic tape 23 extends along the entire axial length of the weld seam 21, i.e., along the longitudinal axis of the submarine power cable 1.

The metallic tape 23 is bonded to the weld seam 23 along the entire axial extension of the weld seam 21. Thus, weld defects along the axial extension of the weld seam 21 located on the radially outer side of the weld seam 21 may be filled as a result of the bonding between the metallic tape 23 and the weld seam 23.

The metallic tape 23 may be made of the same material, or of a material of similar quality, as the metallic water blocking layer 13. With similar quality is meant that if for example the metallic water blocking layer 13 is made of oxygen-free copper such as Cu-DHP, Cu-ETP, or Cu—OF, the metallic tape 23 is also made of oxygen-free copper, although not necessarily the exact same type as the metallic water blocking layer 13. Further, if the stainless steel has a chromium equivalent in a range of 16-25 and a nickel equivalent in a range of 11-22 according to a Schaeffler-DeLong constitutional diagram for which the chromium equivalent is calculated according to the formula % Cr+% Mo+1.5× % Si+0.5× % Nb and the nickel equivalent is calculated according to the formula % Ni+0.5× % Mn+30× (% C+% N), then the metallic tape 23 may also be made of a stainless steel of a type that falls within the area defined by the aforementioned Schaeffler-DeLong constitutional diagram.

The polymeric sheath 15 may be an extruded layer. The polymeric sheath 15 may be extruded onto the metallic water blocking layer 13 after the metallic tape 23 has been placed over the weld seam 23 during manufacturing. The temperature of the polymeric material forming the polymeric sheath 15 during the extrusion process, melts an adhesive or solder provided on an inner surface of the metallic tape 23, facing the weld seam 21. The adhesive or solder thus melts and bonds the metallic tape 23 to the weld seam 21.

The polymeric sheath 15 may be arranged in direct contact with the metallic tape 23. According to one example, the submarine power cable 1 may have an adhesive layer arranged between the polymeric sheath 15 and the metallic water blocking layer 13. In this case, the adhesive bonds the polymeric sheath to the metallic water blocking layer 13 and to the metallic tape 23.

Referring to FIGS. 3-5, a method of manufacturing a submarine power cable such as submarine power cable 1 will now be described in more detail.

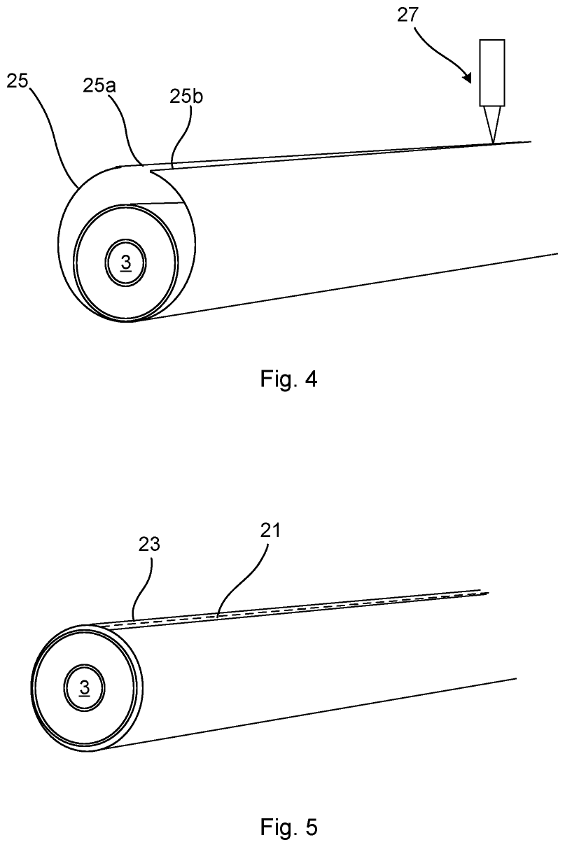

In a step a) a metallic sheath 25, shown in FIG. 4, is wrapped around the insulation system 5. Thus, prior to step a) the conductor 3 has been manufactured, and the insulation system 5 has been provided around the conductor 3, for example by means of extrusion or by winding layers of paper around the conductor 3.

In a step b) opposite edges 25a and 25b of the metallic sheath 25 are welded longitudinally to form the metallic water blocking layer 13 with the weld seam 21. The welding is done by welding equipment 27. The welding may for example be autogenous welding, i.e., the opposite edges 25a and 25b may be welded to each other without using filler material.

After step b) the metallic water blocking layer 13 may be subjected to a diameter reduction process using rollers or a die, for example.

In a step c) the metallic tape 23 is laid over and along the weld seam 21. The metallic tape 23 is thus laid as a strip, longitudinally along the weld seam 21. The metallic tape 23 has a meltable bonding material such as a hot melt adhesive or a solder on its inner surface facing the weld seam 21. The solder may for example have a melting temperature of at most 200° C.

In a step d) the metallic tape 23 is heated to bond the metallic tape 23 to the weld seam 21. The metallic tape 23 is heated at least up to a melting temperature of the adhesive or solder. Due to the heating, the adhesive or solder melts and fuses with the weld seam 21.

Step d) may involve extruding a polymeric sheath 15 around the metallic water blocking layer 13 and the metallic tape 23 to thereby cause the heating of the metallic tape 23 and melting of the adhesive or solder. The extrusion temperature is in this case preferably higher than the melting temperature of the adhesive or solder.

The inventive concept has mainly been described above with reference to a few examples. However, as is readily appreciated by a person skilled in the art, other embodiments than the ones disclosed above are equally possible within the scope of the inventive concept, as defined by the appended claims.

1. A submarine power cable, comprising:
a conductor,
an insulation system arranged around the conductor, the insulation system ng an inner semiconducting layer, an insulation layer arranged around the inner semiconducting layer, and an outer semiconducting layer arranged around the insulation layer,
a metallic water blocking layer arranged around the insulation system, the metallic water blocking layer having a longitudinal weld seam, and a metallic tape arranged radially outside the metallic water blocking layer, wherein the metallic tape extends axially along and is bonded to the weld seam.

2. The submarine power cable as claimed in claim 1, wherein the metallic tape extends along the weld seam 24 along the entire axial length of the weld seam.

3. The submarine power cable (as claimed in claim 1, wherein the metallic tape is bonded to the weld seam by means of an adhesive or by means of solder.

4. The submarine power cable as claimed in claim 3, wherein the solder has a melting temperature of at most 200° C.

5. The submarine power cable as claimed in claim 1, comprising an extruded polymeric sheath arranged around the metallic water blocking layer.

6. The submarine power cable as claimed in claim 5, wherein the polymeric sheath is arranged in direct contact with the metallic tape.

7. The submarine power cable as claimed in any of claim 1, wherein the metallic water blocking layer has a smooth outer surface.

8. The submarine power cable as claimed in claim 1, wherein the metallic tape is made of the same material as the metallic water blocking layer.

9. The submarine power cable as claimed in claim 1, wherein the metallic water blocking layer comprises one of a copper material, or stainless steel.

10. The submarine power cable as claimed in claim 1, wherein the submarine power cable is a high voltage AC or DC submarine power cable.

11. A method of manufacturing a submarine power cable having a conductor and an insulation system arranged around the conductor, the insulation system having an inner semiconducting layer, an insulation layer arranged around the inner semiconducting layer, and an outer semiconducting layer arranged around the insulation layer, the method comprising the
a) wrapping a metallic sheath around the insulation system,
b) welding opposite edges; of the metallic sheath longitudinally to form the metallic water blocking layer with the weld seam,
c) laying the metallic tape over and along the weld seam, and
d) heating the metallic tape to bond the metallic tape with the weld seam.

12. The method as claimed in claim 11, wherein the metallic tape has an inner surface provided with an adhesive or solder, wherein step d) involves melting the adhesive or solder such that the adhesive or solder fuses with the weld seam.

13. The method as claimed in claim 11, wherein step d) involves extruding a polymeric sheath around the metallic water blocking layer and the metallic tape to thereby cause the heating of the metallic tape.

14. The submarine power cable as claimed in claim 2, wherein the metallic tape is bonded to the weld seam by means of an adhesive or by means of solder.

15. The submarine power cable as claimed in claim 2, comprising an extruded polymeric sheath arranged around the metallic water blocking layer.

16. The submarine power cable as claimed in claim 2, wherein the metallic water blocking layer has a smooth outer surface.

17. The submarine power cable as claimed in claim 2, wherein the metallic tape is made of the same material as the metallic water blocking layer.

18. The submarine power cable as claimed in claim 2, wherein the metallic water blocking layer comprises one of a copper material, or stainless steel.

19. The submarine power cable as claimed in claim 2, wherein the submarine power cable is a high voltage AC or DC submarine power cable.
